(19) United States
(12) Patent Application Publication
(10) Pub. No.: US 2005/0289619 A1
(43) Pub. Date: Dec. 29, 2005

(54) Methods and system for resource allocation in an on-demand server

(76) Inventor: Joel Melby, Southborough, MA (US)

Correspondence Address: INTELLECTUAL PROPERTY ADVISORS LLC, PO BOX 156, CANTON, CT, 06019, US

(21) Appl. No.: 11/143,429

(22) Filed: Jun. 1, 2005

Related U.S. Application Data
(60) Provisional application No. 60/576,095, filed on Jun. 1, 2004.
(60) Provisional application No. 60/576,269, filed on Jun. 1, 2004.
(60) Provisional application No. 60/576,338, filed on Jun. 1, 2004.
(60) Provisional application No. 60/576,402, filed on Jun. 2, 2004.

(51) Int. Cl. H04N 7/173

(52) U.S. Cl. 725/95; 725/93

(57) ABSTRACT

A resource allocation method and system configured to establish a streaming session in conjunction with a streaming controller so as to allow a BMCS to intelligently establish, set up and teardown streaming sessions. The resource allocation method and system further manages devices installed with the VOD Server and devices across the steaming networks that are not visible to the existing resource managers.

This application claims the benefit of U.S. Provisional Application No. 60/576,095, filed Jun. 1, 2004, U.S. Provisional Application No. 60/576,269, filed Jun. 1, 2004, U.S. Provisional Application No. 60/576,338, filed Jun. 1, 2004, and U.S. Provisional Application No. 60/576,402, filed Jun. 1, 2004.

### BACKGROUND OF THE INVENTION

1. Field of the Invention

The present invention relates to a method and system for efficiently allocating resources in an on-demand server so as to service simultaneously a large number of streams of audio, video and or other data formats being played out to customers on a network.

2. Background Description

The system and method for resource allocation of the present invention as utilized in the managing and controlling of streaming from an on-demand server is configured to utilize, for example, a solid state, memory based, on-demand server manufactured by Broadbus Technologies, Inc., under the tradenames B-1 and SBB-1, into the operational framework of on demand service operator (ODSO) or other network distribution system with and without the support of a Business Management System (BMS) platform to provide video-on-demand (VOD), subscription video on demand (SVOD), television on demand (TOD), and audio on demand (AOD) services by streaming such content to customers requesting the content. In order to provide VOD SVOD, TOD, AOD or other on-demand service to customers the on-demand service operator (ODSO) such as a cable network operator has to integrate the on-demand server into their operational framework to deliver on-demand service having the following functions:
On-demand or other VOD Server provisioning
Content ingest management
Session setup/stream management
On-demand or other VOD Service Assurance
   A Business Management System (BMS) application provides a frame work for services like movies-on-demand (MOD) and pay-per-view PPV. An all memory VOD Server can be integrated with BMS applications that support open standards (such as Tandberg's Open Stream product) to provide VOD, SVOD, TOD, and AOD services. The Broadbus Management & Control System (BMCS) acts as the integration layer between the VOD Server and an external BMS.

When integrated with an open BMS and cable network, the BMCS works with other entities within the network to identify, reserve, and release the resources needed to deliver content to downstream Set Top Boxes (STBs). These entities may include a network resource manager that manages and controls network resources, and session setup and control protocol gateways. Managed resources include bandwidth capacity within the VOD server, appropriate signal routing between the VOD server and the STBs, and capacity within any necessary transport signal conversion and modulation devices. In some environments, the BMCS need only manage VOD server resources; in others, the BMCS must also coordinate network resource requirements with an external network resource manager. There are also environments in which the BMCS is the only entity responsible for resource management.

The RA component, to be deployed as part of the BMCS, will allow the VOD Manager to do this intelligently, and to manage devices installed with the VOD Server in cooperation with external resource managers. The BMCS enables the cable service operator to configure and control one or more VOD Servers in order to provide the functionality required to ingest content files, set-up VOD sessions at subscriber request and record status information on VOD streams. The BMCS must be able to set up stream-based sessions in cooperation with existing cable network resource management systems.

### SUMMARY OF THE INVENTION

The present invention utilizes a process for a Video On Demand (VOD) Server that can be implemented by software to provide network resource allocation and management for a Broadbus Management & Control System (BMCS) as deployed for a variety of cable network environments. For example, when integrating an on-demand server in a cable network based upon Time-Warner's Integrated Services Architecture (ISA), the BMCS must work with other entities within the network to identify, reserve, and release the resources needed to deliver content to downstream Set Top Boxes (STBs). Information from devices and entities such as a Session and Resource Manager (SRM), which manages and controls network resources, and a Session Gateway (SG), which translates between the Digital Storage Media—Command and Control (DSM-CC) world of the SRM and the Common Objects Request Broker Architecture (CORBA) CORBA-based ISA world. The SRM cannot answer the question “which resources should be used;” it merely answers whether a resource can be used. To set up a session, the BMCS must identify to the SRM the specific resources required, hence the need for a device that answers the “which” question. Also, not all of the required resources are visible to the SRM (for example, Harmonic NSG boxes) and so must be managed by something within the VOD Server/BMCS.

### DESCRIPTION OF THE DRAWINGS

These and other advantages of the present invention are best understood with reference to the drawings, in which:

FIG. 1 is a schematic diagram illustrating the controlling of streaming in an on-demand server distribution system;

FIG. 2 is a schematic diagram illustrating the controlling of streaming in an on-demand server distribution system;

FIG. 3 is a schematic diagram illustrating resource allocation of the stream flow an exemplary embodiment of the present invention;

FIG. 4 is a diagram illustrating controlling resource allocation across two management domains controlled by the SRM/DNCS and by a VOD Manager an exemplary embodiment of the present invention; and

FIG. 5 is a diagram illustrating the Resource Allocator component as an internal component of the management and controlled streaming or as a separate application loaded on separate server according to an alternative embodiment of the present invention.

### DETAILED DESCRIPTION OF THE PREFERRED EMBODIMENT

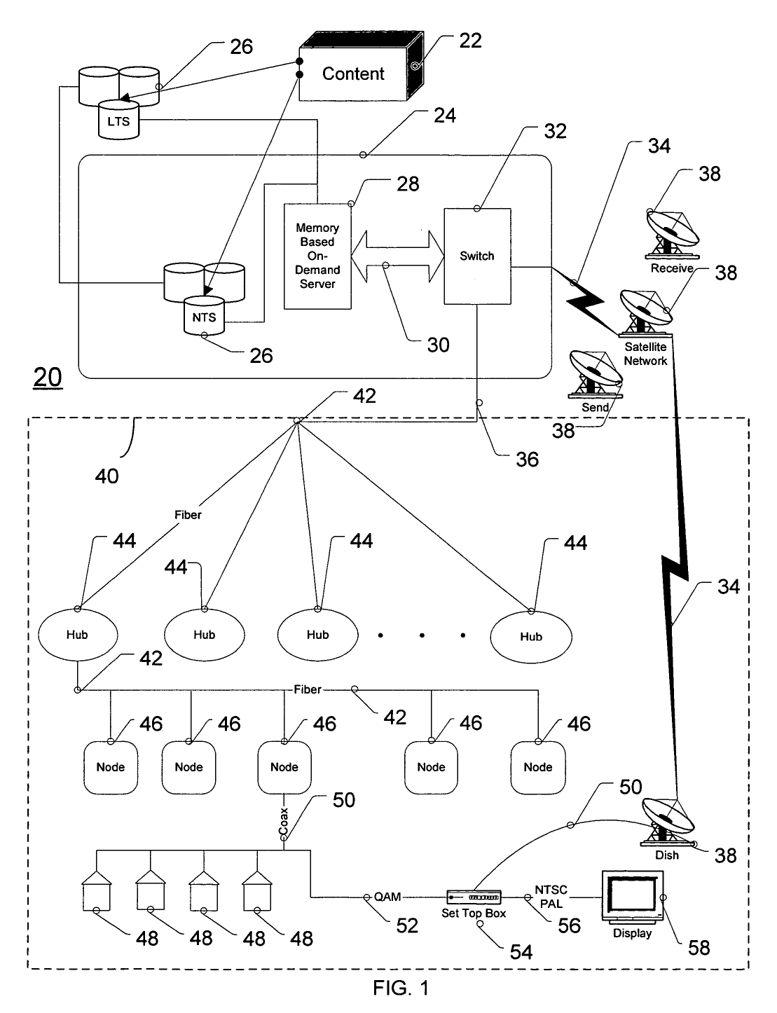

Referring to FIG. 1, a volatile memory based on-demand system is shown generally as element 20. Volatile memory advantageously can be random access memory (RAM) readily available in 1 Gigabyte chipsets. The memory based on-demand system 20 is configured to distribute content 22 to end users such as, for example, in a network distribution system. A head end 24 of the system 20 obtains content from short- or long-term storage in response to requests sent across the network distribution system by the end user or customer. The head end 24 is generally configured with storage 26, such as disk storage from either of the short- or long-term storage that contains the content to be streamed, a volatile, content addressable memory (CAM) based on-demand server 28 such as a B-1 VOD Server or SBB-1 manufactured by Broadbus Technologies, Inc., a wide bus 30 and a switch 32.

Referring to the description herein some terms should be defined for the benefit and clear understanding of the present invention. In a hardware context, concurrency is the number of streams requesting a piece of content. Resident content means content entirely contained in the memory of the on-demand server 28. Segment content is a segment, page or tile of content contained in the memory of the on-demand server 28, whereby only a window around the current stream location is kept in memory. A segment, for purposes of this patent application, is an 8 megabyte piece of content 22. Load is meant to indicate making a content 22 resident in the memory of the on-demand server 28. A credit is meant to be a portion or chunk of near-term-storage (NTS) bandwidth (BW), which in the present application is set to a throughput of four (4) megabits-per-second (mbps), which is the rate relating to the number of credits required by the stream. An overlap occurs each time one or more streams use the same segment of content 22 at the same time. A memory limit is a total memory capacity or amount of memory that can be allocated to streaming. A bandwidth limit is a limit of the total bandwidth that can be allocated, whereby setting the bandwidth limit to high may cause trick modes to stall due to unavailable bandwidth BW. A segmented or paging trick play speed limit means the maximum speed a stream that is segmented content 22 is allowed to be played out at in the trick play mode which has an impact on bandwidth requirements.

Throughout this detailed description content 22 can generally refer to data, audio, visual or audio-visual works such as, for example, a movie file in an MPEG format that is played out to a customer's TV set. It will be appreciated, of course, that the context and examples chosen by the applicant to illustrate the present invention, namely, pulling and playing a movie file to a customer's TV set were chosen for ease of illustrating the principals of the method and system of managing the resources of a RAM based on-demand server according to an exemplary embodiment the present invention. Content 22 also can be obtained and streamed out to a customer in other applications and formats. For example, the content 22 can be another form of data and in another format, specifically, an audio MP3 file. Moreover, data comes in numerous other formats that are streamed to a customer on-demand where it is still advantageous to manage server resources when the server is providing streaming to many, multiple end users in way to display and seamlessly play the requested content 22. As a result, managing information dynamically using a volatile memory based on-demand server across a world-wide network has other applications such as, for example, managing instant messaging, e-mail, streaming video conferencing, audio communications and the like.

The head end 24 illustrated in FIG. 1 connects to various distribution systems to distribute content 22 wirelessly 34 or physically on a land line 36, or both. For example, wireless distribution 34 involves connecting the head end 24 to a satellite distribution network 38. Similarly, distribution by land line 36 connects the head end 24 to a high-speed fiber optical network 40 that can be configured, for example, to have high speed fiber optic lines 42, connected to hubs 44, with such hubs 44 connected to nodes 46, and the nodes connected to individual end-users 48, e.g. a particular home or residence. Distribution of content 22 to a particular customer on-demand on a network, for example, network 40. Presently, cable distribution of content 22 to an end user's residence uses coaxial cable 50 via Quaternary/Quadrature Amplitude Modulation (QAM) 52 to a distribution device such a set top box 54 that converts to a PAL or NTSC signal 56 input into an appropriate device 58 that can play out the content 22 such as, for example, a TV, HDTV, LCD, a media center or other displaying device.

In an exemplary embodiment of the present invention, the method begins by ordering usage of the memory based on sorting the concurrency for a particular piece of content 22. Resident Content is content loaded entirely into the memory of the on-demand server 28. When a customer makes a request, the BMCS 72, and or related software of the BMCS 72, instructs the server 28 and related components to ingest, or otherwise obtain and load, the content 22 into memory of the server 28. The BMCS 72 makes a request to the server 28 to go out to disk storage, either long term or near term storage, ingesting the content 22 and transferred it to the RAM memory of the server 28. In the simplest example, the memory of the server 28 is empty for the first on-demand request for a particular piece of content 22 by a customer or other end user, e.g. such as a full length feature movie. Here, the content 22 is loaded entirely into memory, or made resident. The starting point of the movie is designated zero and given a corresponding starting address in the content addressable memory (CAM) of the server 28, which is managed separately.

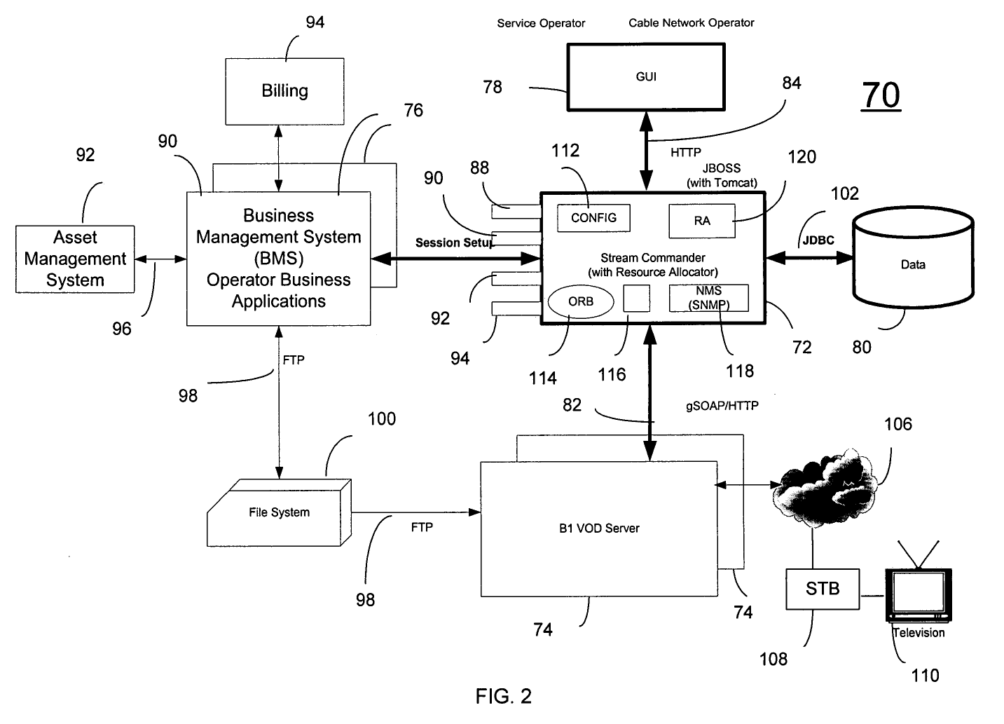

Referring to FIG. 2, an exemplary embodiment of the present invention describes the system for controlling 70 the streaming of content in the on-demand system 20. A BMCS software and process 72 connects to one or more on-demand or VOD servers 74, a business management system (BMS) 76, a graphical user interface (GUI) 78, and a data warehouse 80. The BMCS 72 connects to the VOD server 74 via a SOAP interface 82 or HTTP interface 84. The SOAP interface 82 advantageously is open to management by other third parties. The HTTP interface 84 has advantages as an internet standard protocol. The BMS 76 advantageously connects to BMCS 72 utilizing various adaptors or protocols from different on-demand network operators (ODNO). Such ODNO open standards include ISA 86 published by Time-Warner, or combination protocol J2EE and RTSP 88 published by Telenet, combination protocol XML-over-HTTP and RTSP 90 published by C-Cor, combination protocol ISA and RTSP published by UPC, and combination protocol RTSP and XML-over-HTTP 94 published by Comcast. The BMS 76 is connected to an Asset Management System 92 and Billing System 94 via a standard bus interface 96. The BMS 76 connects to the on-demand server 74 through a file system 100 to effectuate transferring content files by file transfer protocol 98. The GUI 78 connects to BMCS 72 via a standard HTTP interface 84. The data warehouse 80 connects to BMCS 72 via a JDBC interface 102. Once content 22 has been loaded to the on-demand or server 74, it can be streamed under the control of the streaming controller 72 via an MPEG-2 Transport Stream 104 along a network path 106 to a customer's set top box 108 and displayed on the consumer's television 110.

The managing and streaming control system or BMCS 72 has several internal processes functioning to configure the system 112 (both the VOD server 74 and the Resource Allocator 120), an external protocol gateway, such as a CORBA ORB 114, processing error messages and system alarms 116, a network management system (NMS) 118 (typically operating SNMP standard), and the Resource Allocator. The BMCS's 72 major functions are to (1) configure 112 the VOD server 74 and provide stream data to the Resource Allocator 120; (2) to ingest content 22; (3) to stream the content from the on-demand server 74; and (4) monitor system alarms, error messages and SNMP messages.

The on-demand server 74 is configured to control dynamically streaming functions such as, for example, loading content 22 entirely into memory 64, loading portions or segments of content 22 into memory 66, managing near-term-storage (NTS) bandwidth 68 limits and or limitations, and managing of playback functions 70 such as trick play modes and analyzing the speed of playing out the trick play in the stream to customers on-demand. For example, in the on-demand server of the present invention, content 22 demanded by an end user can be either pulled entirely into the memory or pulled into memory in segments from disk storage 26. Information about streams must be maintained for several reasons including recovery information from Resource Allocation status so as to recover, for example, after a failure of the BMCS 72. Another reason to maintain information about the streams is more historical so as to maintain information about subscriber behavior like number of trick commands and their type, pause duration, etc.

The BMCS 72 records information about active and suspended streams, whereby active streams are streamed from on-demand server 28 and suspended streams are streams for which the session was destroyed but the media file was not streamed up to the end by the BMCS 62 such as, for example, when the user resumes watching a paused program content 22 the BMCS 72 can provide index information to resume the playback. The BMCS 72 operates to receive packages containing assets and MPEG content files sent from a media provider or other asset owner to the cable or satellite network. The cable or satellite network uses a catcher to receive the packages and assets, which the catcher forwards to the asset manager application. The asset manager application records the association between the assets and their related content files and signals the FTP transfer of the content 22 from the catcher to the on-demand server 28. The BMCS 72 maintains the association between the contents 22 and the on-demand server 28 that store them on its NTS 26. The main content management functionality of the BMCS 72 is to:
Maintain information about all of the Content 22 files installed on the on-demand server 28.
Provide functionality to remove Content 22 files.
Create and maintain a unique handle for the content file and forward it to the VOD Server.
Provide the following Content 22 information to the on-demand server 28 including, but not limited to, bit-rate, path (URL containing IP address, user and password), and unique content ID.
Provide persistence for asset and Content 22 information.
Notify the on-demand server 28 about Content 22 ingest request.
Generate an alarm when a Content 22 ingest failed.
Log the Content 22 ingest events.

The Resource Allocator 120 operates as part of the BMCS 72 to deliver content 22 by managing the resources necessary to stream such content 22 through a cable network to an on-demand customer. The Resource Allocator 120 enables the on-demand service operator (ODSO) such as a cable, fiber, satellite, or other network service operator to configure and control one or more VOD Servers 74 in order to ingest content files 22, set-up VOD sessions at subscriber request and record status information on VOD streams. For example, in an existing cable network 106, the BMCS 72 can set up stream-based sessions in cooperation with existing cable network resource management systems 106. The Resource Allocator 120 component of the BMCS 72 allows the BMCS 72 to intelligently set up streaming sessions and to manage devices installed with the on-demand Server 74 in cooperation with external resource device managers.

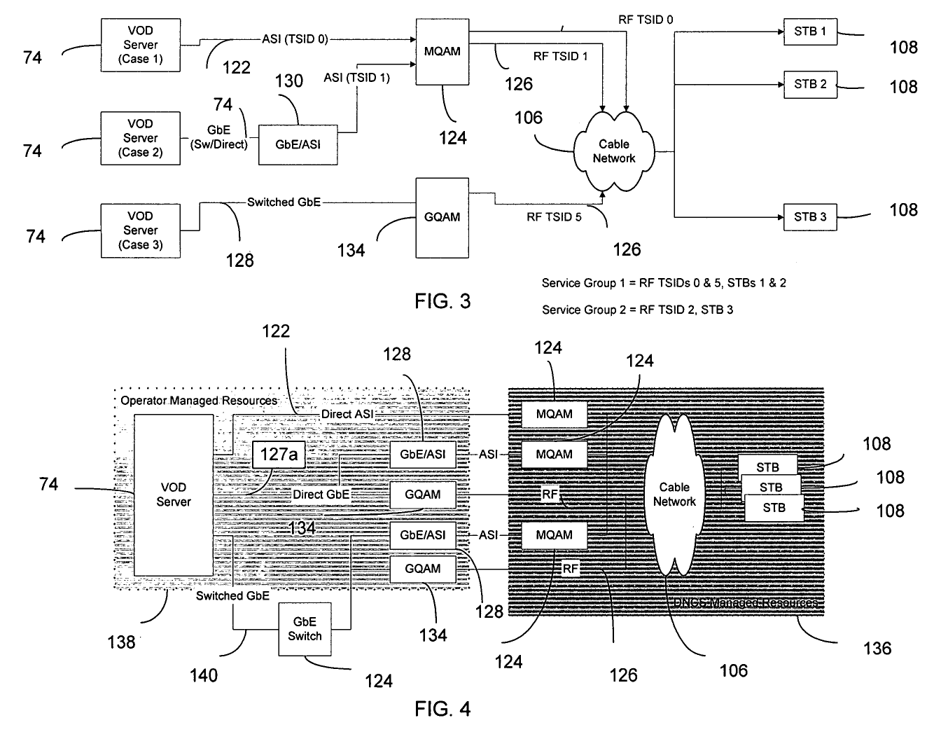

Referring to FIG. 3, the basic network path for VOD streams is described where a content stream is generated by the VOD Server 74 as a Single-Program Transport Stream (SPTS). Through various means, several SPTSs are integrated into Multi-Program Transport Streams (MPTSs) for modulation and upconversion to RF channels (by, for example, a Quaternary/Quadrature Amplitude Modulation (QAM) or variant thereof). The resulting RF signal is distributed through the cable network and received, demodulated, de-multiplexed, and decoded by the STBs 108. When a customer orders a movie, the VOD client application in the customer's STB 108 is told which RF channel to decode and which program stream within the channel to display.

Streams can be sourced into the network 106, for example, a cable network via multiple means. Referring to the upper resource allocation path in FIG. 3 when streaming content to one or more STBs 108 designated as Case 1. The VOD server 74 begins to stream content and sends it along a Digital Video Broadcast Asynchronous Serial Interface (DVB-ASI, or ASI) 122 to a multiple QAM modulator (MQAM) device 124 such as manufactured by Scientific Atlanta. In this example, the MQAM 124 can drive four RF channels 126 from two ASI inputs. Each ASI 122 input carries a single packetized transport stream (SPTS) or multi-packetized transport stream MPTS signal and is identified with a transport stream TSID unique within the management domain, as are the TSIDs for each RF channel 126 output. Each RF output supports a single MPTS (with its own TSID, not necessarily the same as the ASI input TSID), for a theoretical aggregate bandwidth of 42 Mbps (256QAM). Streams within the MPTS are disambiguated by MPEG program number.

Referring to the middle resource allocation path in FIG. 3 when streaming content to one or more STBs 74 designated as Case 2. The VOD server 74 begins to stream content and sends it via switched and/or direct Gigabit Ethernet 127 to a device that converts between Gigabit Ethernet 127 to a DVB-ASI transport (GbE/ASI device) 128, which sends the content to multiple QAM modulator (MQAM) 124 devices such as manufactured by Scientific Atlanta. By using a Gigabit Ethernet (GbE)-to-ASI converter 130 device such as manufactured by Harmonic under the name Harmonic 8204, a VOD Server 74 can source streams via ASI 122 and GbE 128 to existing MQAMs 124. Typically, a GbE-to-ASI converter 130 operates by mapping UDP ports on the GbE interface to specific ASI outputs and program numbers within the MPTS's sent out the ASI outputs.

Referring to the lower resource allocation path in FIG. 3 when streaming content to one or more STBs 108 designated as Case 3. By using a GbE-to-QAM device (GQAM) 134 device such as manufactured by Harmonic under the name Harmonic's 8108, a VOD Server 74 can source streams via GbE-to-QAM device (GQAM), whereby the whole ASI trip can be avoided. As in the GbE/ASI converters 130, these GbE-to-QAM device (GQAM) devices 134 map UDP ports to RF channel outputs and program numbers within the MPTS's sent out the RF channel 126 outputs. Advantageously, improved performance can be obtained utilizing multiple switched GbE environments using Harmonic 8108's and such performance is useful such as, for example, in a Mystro deployment.

Within many ODNOs, stream-level connectivity is managed in terms of service groups as opposed to individual STB addresses. A service group is typically defined as a collection of QAM outputs such as, for example, RF channels, identified by a transport stream TSID, configured to reach a specific collection of STBs generally referred to as 108, however, the STBs can be replaced by a cable modem or DSL modem. The MPTS transmitted via one of the service group's TSIDs is receivable by every STB 108, cable modem, or DSL modem currently in the service group. A specific STB's stream is identified by MPEG program number and a content stream targeted for a specific customer can be identified at the edge of the RF plant by combination of RF TSID and MPEG program number. A service group then works out to be a pool of TSIDs. Typically, the binding of a particular STB with a service group is static; although, it can be dynamic whereby the STB can change service groups. As a result, the resource management “equation” thus boils down to:
Given a collection of servers that can deliver the requested content, the STB's service group, and a stream bandwidth requirement, determine and reserve the network bandwidth and path (as identified by a collection of TSIDs and MPEG program number). When using GbE devices between the VOD Server and cable network edge, determine the device IP address and UDP port that corresponds to the selected network path and determine the VOD Server streaming interface and UDP that can reach the said device IP address.

The Resource Allocator component must support the BMCS' response time limits, typically 500 msec for a streaming session setup. The system capacity of the RA component must support the BMCS' system capacity requirements. The following assumes the majority of content is in the form of standard-definition programs.
One BMCS instance is expected to manage 8 B1 servers with 10 blades each, and each blade has 8 GbE ports, for a total of 640 ports.
Each port can support a maximum of about 950 Mbps. Currently, the VOD Server can support 7 Transport Stream packets per UDP packet (1316 bytes per UDP packet), plus the UDP/IP_overhead of 48 bytes. This means total bandwidth per stream is about 4% higher than the content bandwidth, which averages somewhere between 3.55 Mbps and 3.75 Mbps for a standard-definition program. Given an average total stream bandwidth of between 3.68 Mbps and 3.9 Mbps, a single GbE port can thus drive around 240-260 streams. One BMCS instance must thus be able to manage a maximum of 160,000 concurrent streams.
An MQAM can drive four outputs at 42 Mbps per output, which works out to be around 12 programs per TSID/output. Therefore, a single MQAM can handle roughly 48 streams, and the BMCS/RA must be able to manage MQAM-related resources (edge TSIDs, RF TSIDs, channel bandwidths, and program numbers) for on the order of 3333 MQAM devices.

The RA component can installed as part of the BMCS or as a separate component during BMCS installation. When deployed as a separate component, the RA component will consist of the RA component running on an server packaged as a separate deployment package and a RA Client bundled in the BMCS deployment package. The RA component will run on the same operating systems as the BMCS, such as Unix/Solaris 8 or Linux Red Hat.

Referring to FIG. 4, resource allocation occurring across two management domains: network managed resources 136 such as, for example, those controlled by an external network resource manager (NRM); and internally managed resources 138 controlled by the BMCS. Referring to FIG. 4, several types of stream interfaces may exist concurrently across the Broadbus/NRM domain interface:
Direct ASI interfaces to NRM-managed QAMs can be established from the VOD server 74 along a direct ASI interface 122, or to a Gbe?ASI Converter 128, to a MQAM to the cable network 106 and received by the set top box(es) 108.
Direct RF interfaces from internally managed QAMS can be established from the VOD server 74 along a direct GbE interface 127a to a GbE/ASI converter 128 and/or GQAM 124 converter to an RF channel to the cable network 106 and received by the set top box(es) 108.
Direct or switched Gigabit Ethernet (GbE) interfaces (not shown) to NRM-managed GbE-driven QAMs.

The VOD Manager is responsible for managing the resources within its domain (such as server streaming ports, GbE/ASI converters 128 and GbE-driven QAMs 134) and cooperating with an external NRM to effectively manage resources in the NRMs' domain. The RA component bridges the domains and is responsible for:
Managing resources in the Broadbus domain (answering the “which should I use” question).
Identifying resources in the NRM domain (answering the “which one should I ask for” question for non-Broadbus resources).
Allocating resources across both domains (answering the “which one should I ask for” question).

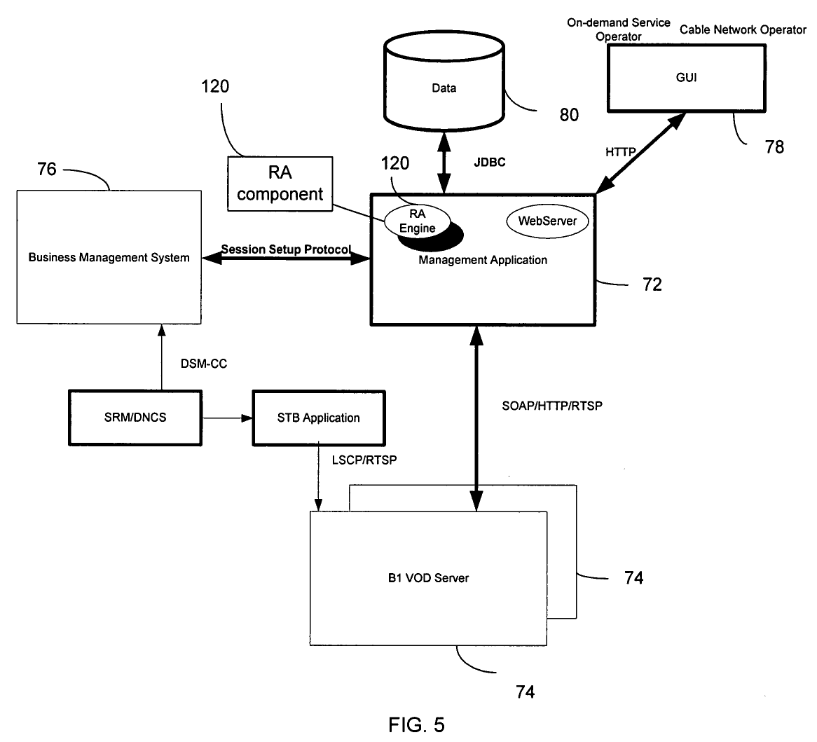

Referring to FIG. 5, resource allocation as an internal component of the BMCS or as a separately deployed component according to an alternative embodiment of the present invention. The RA component is embedded within the BMCS and handles the resource management-related aspects of session setup and teardown. In a session setup, given the collection of VOD servers capable of streaming the requested content, the requesting STB's service group, and the estimated network bandwidth required by the content stream, the RA will do the following:
1. Determine the optimum path selection, based upon current path usage.
2. From the selected path, determine the externally managed resources required. These resources include downstream bandwidth, edge and RF transport stream identifiers (TSIDs), and MPEG program numbers.
3. Keep track of the internally managed resources required, such as VOD server streaming port bandwidth, VOD server control ports, and Broadbus-managed GbE/ASI or GbE/QAM ports.
4. Inform the BMCS of the source and destination IP addresses and UDP ports to be used by the VOD Server when setting up the content stream, and provide a list of resources bound to the session.

The Resource Allocator (RA) component deployed as part of the BMCS will intelligently handle these cases and provide the resource management necessary for streaming on-demand content based on the following use cases:

Use Case 1: Entirely network-managed environment, whereby an external entity is responsible for managing path selection for the entire network having components and protocols of nCUBE, N2BB, OpenStream on Motorola head ends. It is not essential for the RA component to know the network topology. As a result, when asked to set up a session, the RA component is given a destination address, selects a streaming port and UDP value, as well as a control address and a TCP port, on the on-demand server.

Use Case 2: Entirely server-managed environment, whereby the RA component is responsible for managing path selection for the entire network. Network configurations use direct GbE/RF converters and continuous-feed sessions. Here, the RA component manages the path selection and does not need to coordinate the selection with an external NRM. In setting up a session:
1. The RA component will select the RF output (TSID) using one of three algorithms: least-loaded, most-loaded, or mixed-mode. For example, the least-loaded algorithm chooses the output with the most available bandwidth. This algorithm gives the closest appearance to a round-robin approach. The most-loaded algorithm attempts to fill up an output before moving to the next. The mixed-mode algorithm was defined by Time-Warner as a means of better handling mixed standard-definition and high-definition streams. It uses the least-loaded algorithm until a high-water mark is reached, after which the most-loaded algorithm is used.
2. The RA component will select the MPEG channel number based upon constraints set by the administrator on the RF output.
3. The RA component will select the edge UDP port based upon the device's port map, the selected RF output, and the selected MPEG channel.
4. The RA component will select a streaming port and UDP value, as well as control address and TCP port, on the VOD server.

Use Case 3: Server edge-managed environment, whereby The RA component is responsible for managing path selection, but must coordinate QAM resource requirements with the network having components and protocols of N2BB, OpenStream and on S-A head ends, using exclusive sessions. The RA component manages the path selection and coordinates the use of QAM resources (edge TSID, RF TSID, and MPEG channel) with an external NRM. In setting up a session:
1. The RA component will select the RF output (TSID) using one of three algorithms: least-loaded, most-loaded, or mixed-mode. For example, the least-loaded algorithm chooses the output with the most available bandwidth. This algorithm gives the closest appearance to a round-robin approach. The most-loaded algorithm attempts to fill up an output before moving to the next. The mixed-mode algorithm was defined by Time-Warner as a means of better handling mixed standard-definition and high-definition streams. It uses the least-loaded algorithm until a high-water mark is reached, after which the most-loaded algorithm is used.
2. The RA component will select the MPEG channel number based upon constraints (starting and ending channel numbers) set by the administrator on the RF output.
3. The RA component will select the QAM input (edge TSID) based upon any constraints set by the administrator on the QAM inputs. If only one input is in use, the selection is easy. If two inputs are in use, BMCS will pick the one for which the specified constraints fit the selected MPEG channel. If no constraints have been specified, The RA component will use default constraints determined from the constraints configured on the RF outputs.
4. The RA component will select the edge device and input UDP port based upon the device's port map, the selected edge TSID, and the selected MPEG channel.
5. The RA component will select a streaming port and UDP value, as well as control address and TCP port, on the VOD server.

Use Case 4: Mixed environment, the network is a mix of network-managed service groups, server-managed service groups, and server edge-managed service groups, whereby an N2BB, OpenStream on S-A head ends in which several service groups are fed by S-A GQAMs and the remainder are fed by MQAMs. In this example, The RA component will follow use cases 1, 2, or 3, depending upon service group configuration. Here, OpenStream and the DNCS can support a mixed environment; and VOD server streaming ports feeding a network-managed service group are switched and on the same subnet or VLAN.

Although exemplary embodiments of the present invention have been shown and described with reference to particular embodiments and applications thereof, it will be apparent to those having ordinary skill in the art that a number of changes, modifications, or alterations to the invention as described herein may be made, none of which depart from the spirit or scope of the present invention. For example, the functional units can be implemented in hard-wired circuitry, by programming a general purpose processor, or by any combination of hardware and software implemented in a number of different programming languages (including but not limited to C, C++, C#, and Java), using any of a number of different frameworks (including, but not limited to .NET and J2EE), that execute on a number of different operating systems (including, but not limited to Linux in all its variations, Solaris, Unix in all its variations, Mac OS/X, and a number of different Microsoft variations). All such changes, modifications, and alterations should therefore be seen as being within the scope of the present invention.

1. A method for resource allocation for efficient streaming in an on-demand, memory-based server, comprising:
identify a collection of VOD servers capable of streaming the requested content
identify the portion of the video distribution network that can reach the requesting STB (i.e., the service group);
identify a stream bandwidth requirement;
determine available network bandwidth, an optimum network path, an optimum VOD server streaming interface, and associated VOD server resources;
reserve said network bandwidth, said network path, said VOD server streaming
setting up streaming sessions with the VOD Server to stream content to a customer on-demand.

2. The method of claim 1, further comprising the step of:
said network path is identified by one or more of the group of MPEG-2 transport stream identifiers (TSIDs) and MPEG program number.

3. The method of claim 1, further comprising the step of:
said network path is determined by the device IP address and UDP port when utilizing Gigabit Ethernet (GbE) devices corresponding to the selected network path identified between the VOD Server and the network edge of the on-demand service operator (ODSO).

4. A method for resource allocation for a streaming session in an on-demand, memory-based server, comprising:
determining an identifier for a collection of possible network paths to an STB [(in the ISA world, this is referred to as a service group)];
determining the collection of VOD servers that can stream the requested content;
estimating network bandwidth required by a content stream; and
allocating resources of the on-demand server characterized by:
determining an optimum path based upon current path usage using either a least-loaded, most-loaded, or mixed usage model;
identifying required externally managed resources from downstream bandwidth, MPEG-2 transport stream identifiers (TSIDs) and MPEG program number.

5. The method according to claim 4, further comprising the step of:
determining a selected optimum path based on a current path usage.

6. The method according to claim 5, further comprising the step of:
tracking internally managed resources including VOD server streaming bandwidth, interfaces and UDP ports, VOD server control interfaces and UDP or TCP ports, GbE/ASI converter input bandwidth, interfaces, and UDP ports, GbE/ASI converter output bandwidth and interfaces, GbE/QAM input bandwidth, interfaces, and UDP ports, GbE/QAM output bandwidth and interfaces, and MPEG program numbers.

7. The method according to claim 6, further comprising the step of:
informing the VOD Manager of source and destination IP addresses and UDP ports, as well as a stream control IP address and control UDP or TCP port to be used by the VOD Server when setting up the content stream; and
providing a list of said of externally managed resources bound to the session.

8. A resource allocation system configured to establish a streaming session from an array of ordered values, wherein the array of ordered values has a first value and a last value, the resource allocation system comprising:
means for determining an identifier for a collection of possible network paths to an edge device;
means for comparing said possible network paths to said edge device]
means for selecting a path from a comparison to determine the internally and externally managed resources required including downstream bandwidth, MPEG-2 transport stream identifiers (TSIDs), and MPEG program numbers;
means for tracking the internally managed resources including VOD server streaming bandwidth, interfaces and UDP ports, VOD server control interfaces and UDP or TCP ports, GbE/ASI converter input bandwidth, interfaces, and UDP ports, GbE/ASI converter output bandwidth and interfaces, GbE/QAM input bandwidth, interfaces, and UDP ports, GbE/QAM output bandwidth and interfaces, and MPEG program numbers using a database;
means for informing the VOD Manager of the source and destination IP addresses and UDP ports, as well as a stream control IP address and control UDP or TCP port to be used by the VOD Server when setting up the content stream, and provide a list of resources bound to the session.

9. The system according to claim 8, wherein the edge device is a service group (in the ISA world), a cable modem, a DSL modem, or a STB.

10. The system according to claim 8, wherein the resource allocator performs a streaming session teardown by determining the internal and external resources that can be released from the session so as to return the resources to the free state.

11. The system according to claim 10, wherein the resource allocator performs a streaming session teardown by further returning the internal resources to the free state.

12. A computer-readable medium having stored thereon a plurality of sequences of instructions, said plurality of sequences of instructions including sequences of instructions which, when executed by a processor, cause said processor to perform the steps of:
determining an identifier for a collection of possible network paths to an edge device;
comparing said possible network paths to said edge device;
selecting a path from a comparison to determine the internally and externally managed resources required including downstream bandwidth, MPEG-2 transport stream identifiers (TSIDs), and MPEG program numbers;
tracking the internally managed resources required, such as VOD server streaming bandwidth, interfaces and UDP ports, VOD server control interfaces and UDP or TCP ports, GbE/ASI converter input bandwidth, interfaces, and UDP ports, GbE/ASI converter output bandwidth and interfaces, GbE/QAM input bandwidth, interfaces, and UDP ports, GbE/QAM output bandwidth and interfaces, and MPEG program numbers using a database; and
informing the VOD Manager of the destination IP address and UDP port to be used by the VOD Server when setting up the content stream, and provide a list of resources bound to the session.

13. A computer software product that includes a medium readable by a processor, the medium having stored thereon:
a first sequence of instructions which, when executed by said processor, causes said processor to determine an identifier for a collection of possible network paths to an STB [(in the ISA world, this is referred to as a service group);
a second sequence of instructions which, when executed by said processor, causes said processor to estimate network bandwidth required by a content stream; and
a third sequence of instructions which, when executed by said processor, causes said processor to allocate resources of the on-demand server characterized by:
a fourth sequence of instructions which, when executed by said processor, causes said processor to determine an optimum path based upon current path usage;
a fifth sequence of instructions which, when executed by said processor, causes said processor to identify required externally managed resources from downstream bandwidth, MPEG-2 transport stream identifiers (TSIDs), and MPEG program number; and

14. The method according to claim 13, further comprising the step of:
another sequence of instructions which, when executed by said processor, causes said processor to determine a selected optimum path based on a current path usage.

15. The method according to claim 14, further comprising the step of:
another sequence of instructions which, when executed by said processor, causes said processor to track internally managed resources including GbE/ASI converter ports.

16. The method according to claim 15, further comprising the step of:
another sequence of instructions which, when executed by said processor, causes said processor to inform the VOD Manager of a source and destination IP addresses and UDP ports, as well as a stream control IP address and control UDP or TCP port to be used by the VOD Server when setting up the content stream; and
another sequence of instructions which, when executed by said processor, causes said processor to provide a list of said of externally managed resources bound to the session.
